(19) United States
(12) Patent Application Publication
(10) Pub. No.: US 2005/0198304 A1
(43) Pub. Date: Sep. 8, 2005

(54) System and method for access point translation of web service content

(76) Inventors: Ian Oliver, Soderkulla (FI); Juha Savolainen, Helsinki (FI)

Correspondence Address: CRAWFORD MAUNU PLLC, 1270 NORTHLAND DRIVE, SUITE 390, ST. PAUL, MN, 55120, US

(21) Appl. No.: 10/758,235

(22) Filed: Jan. 15, 2004

(51) Int. Cl. G06F 15/16

(52) U.S. Cl. 709/227; 709/236; 709/246

(57) ABSTRACT

A system and method for using a network access point to implement transparent Web Service functionality between processing deficient terminals and Web Service providers by allowing the terminals to access Web Services using abbreviated Web Service requests. The abbreviated Web Service requests are then translated into conventional Web Service requests by the network access point and subsequently forwarded onto the Web Service provider. The conventional Web Service response is then optionally translated into an abbreviated response to accommodate the processing deficiencies of the Web Service requester.

### FIELD OF THE INVENTION

This invention relates in general to Web Services, and more particularly to a system and method for transparent Web Service functionality.

### BACKGROUND OF THE INVENTION

Internet usage has conventionally involved a model whereby services are provided to Internet users via, for example, the HyperText Transport Protocol (HTTP) using textual content, such as HyperText Markup Language (HTML), Wireless Markup Language (WML), eXtensible Markup Language (XML), or variants thereof. The Internet is now evolving into a distributed model, whereby services are consumed in an automated, or mechanized, fashion by autonomous computing systems that do not necessarily directly involve a human being. Thus, a Web Services paradigm of computing has emerged, whereby client systems interact with services using a model based on a rich set of meta-data that is made possible with an interpretable markup language.

Web Services are not specific to any particular platform or any particular vendor's development environment, thus they allow heterogeneous Internet tools to: 1.) discover the desired Web Services for invocation; 2.) interpret Web Service offerings available from a registry of services; 3.) invoke the Web Services with the appropriate request parameters; and 4.) interpret the responses from the Web Services correctly. To that end, the Simple Object Access Protocol (SOAP) was developed to provide a message framework that defines message structure, processing mechanisms, a set of encoding rules to represent service-specific data types, and a convention to enable Remote Procedure Calls (RPC) or message exchange.

Accordingly, the SOAP message framework using XML (SOAP/XML), while enabling autonomous computing systems to access Web Services, is also quite verbose with respect to the information embodied within the SOAP representations. The SOAP message framework, therefore, is targeted toward client-server architectures that may be found in conventional computing systems within, for example, a gigabit Ethernet or T1 network infrastructure. Such computing systems are typically equipped with robust Central Processing Units (CPU) operating at gigabit per second clock speeds with ample system memory and thus are well adapted to accommodate the processing requirements imposed by SOAP/XML.

Internet users are becoming increasingly mobile and thus are relying more heavily on wireless access to the Internet. Typically, however, the mobile terminals used to access the Internet are equipped with limited computing resources as compared to the resources found in SOAP compliant server-client architectures on landline networks. Thus, the mobile communication domain suffers due to the physical constraints imposed by the low availability CPUs and lower access bandwidths of the mobile terminals.

Although the transmission of SOAP/XML over a wireless medium is possible, the amount of payload carried in relation to actual data transmitted is exceptionally low. Accordingly, there are efforts to standardize binary formats for the transport of SOAP/XML in order to increase the payload to data efficiency, however, these efforts do not address the need to lower the bandwidth usage in a mobile environment.

A compression algorithm may be implemented within the mobile terminal in order to decrease the transmission bandwidth required to exchange the SOAP/XML messages, but the compression algorithm itself requires extensive CPU access and high memory usage. Thus, data compression fails as a viable alternative to transmission of SOAP/XML representations over a wireless medium.

Accordingly, there is a need in the telecommunications industry for a solution that allows Web Service access from mobile terminals using a low bandwidth, Over the Air (OTA) channel, while minimizing the burden imposed upon their limited CPU access and memory deficiencies. Such a solution would also benefit a Personal Digital Assistant (PDA) or other minimal resource terminal that may be used to access the Web Services from a landline connection.

### SUMMARY OF THE INVENTION

To overcome limitations in the prior art described above, and to overcome other limitations that will become apparent upon reading and understanding the present specification, the present invention discloses a system and method for providing transparent Web Service functionality.

In accordance with one embodiment of the invention, a method for transparently accessing Web Services by a network terminal via a network access point comprises receiving a Web Service request from the network terminal by the network access point, optionally translating the Web Service request into a first format, receiving a Web Service response in the first format, and optionally translating the Web Service response into a second format. The second format is indicative of processing capabilities of the network terminal.

In accordance with another embodiment of the invention, a Web Service consumption system comprises a network terminal that is adapted to request a Web Service in a translated format and is also adapted to receive a response to the request in the translated format. The Web Service consumption system further comprises a network access point coupled to receive the request and is adapted to convert the request into a conventional format. The Web Service consumption system further comprises a service provider coupled to receive the request from the network access point and that is adapted to provide the response to the request in the conventional format. The network access point is further adapted to convert the response into the translated format prior to forwarding the response to the network terminal.

In accordance with another embodiment of the invention, a mobile terminal is wirelessly coupled to a network that includes a network access point capable of translating Web Service exchanges between the mobile terminal and a service provider. The mobile terminal comprises a memory capable of storing a messaging module and a processor coupled to the memory that is configured by the messaging module to enable a message exchange with the network access point. The messaging module is adapted to instruct the network access point to convert the messages received from the mobile terminal to a format compatible with the service provider.

In accordance with another embodiment of the invention, a computer-readable medium having instructions stored thereon which are executable by a network terminal for consuming Web Services. The instructions perform steps that comprise transmitting a Web Service request in a first format to a network access point, signalling the network access point to convert the Web Service request from the first format to a second format, and receiving a response to the Web Service request from the network access point. The response received is also in the first format due to the signalling received by the network access point to convert the Web Service request.

In accordance with another embodiment of the invention, a network access point within a network is used to facilitate a Web Service exchange between a service requestor and a service provider. The network access point comprises a means for receiving a service request in a first format from the service requester, a means for translating the service request from the first format into a second format in response to signalling received from the service requester, a means for receiving a service response in the second format from the service provider, and a means for translating the service response from the second format to the first format in response to signalling received from the service requester.

In accordance with another embodiment of the invention, a computer-readable medium having instructions stored thereon which are executable by a network access point for facilitating Web Service consumption. The instructions perform steps that comprise receiving a service request in a first format from the service requester, translating the service request from the first format into a second format in response to signalling received from the service requestor, receiving a service response in the second format from the service provider, and translating the service response from the second format to the first format in response to signalling received from the service requestor.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described particular examples in accordance with the invention.

### BRIEF DESCRIPTION OF THE DRAWINGS

The invention is described in connection with the embodiments illustrated in the following diagrams.

FIG. 1 illustrates a representative network implementing the principles of the present invention whereby terminals can participate in Web Service transactions using translated Web Service requests and responses from network access points;

FIG. 2 is a block diagram of a basic network architecture incorporating a network access point as a SOAP translation device in accordance with the present invention;

FIG. 3 is an exemplary network diagram capable of supporting transparent Web Service usage in accordance with the present invention;

FIG. 4A illustrates a conventional SOAP/XML service request;

FIG. 4B illustrates a conventional SOAP/XML service response;

FIG. 5 is an exemplary flow diagram in accordance with the present invention;

FIG. 6 illustrates a representative mobile computing arrangement in accordance with the present invention; and

FIG. 7 is a representative computing system capable of carrying out network access point functions according to the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention facilitates access to SOAP/XML based Web Services from terminals having limited computational resources by placing SOAP/XML translation modules within network access points such as, for example, a Wireless Access Protocol (WAP) gateway or Internet Service Provider (ISP). In general, any connection made over any network port, e.g., HTTP port 80, that exchanges SOAP/XML data may be adapted to first detect the presence of the SOAP/XML content and then perform any necessary translation/filtering operations on the SOAP/XML content as required by the requesting terminal.

For example, most RPC style calls incorporate a SOAPAction HTTP header field that may be detected in accordance with the present invention, which subsequently causes the SOAP body to be filtered/translated to accommodate the requesting device. It is contemplated that the placement of the SOAP translation modules may be accomplished at any node within the network, so long as that node has sufficient processing power to accommodate the needs of the SOAP translation/filtering process.

The present invention offloads the processing deficient network terminal from the task of compression/transmission of the SOAP representations and instead imposes a translation/filtration requirement upon the network access point that is communicating with the network terminal. In the case of a mobile terminal, for example, the network element, e.g., a WAP gateway or Session Initiation Protocol (SIP) proxy, that is performing the translation/filtration process may reduce the transmission payload intended for the mobile terminal. Accordingly, the transmission bandwidth utilized to communicate the converted SOAP representation to the mobile terminal is minimized. Similarly, in the case of a landline terminal having limited computational facilities, the network access point, e.g., an ISP, may perform any translation/filtration process on the SOAP representations that may be required by the landline terminal.

Web Services are typically provided over a transport layer such as HTTP, SMTP, FTP, or other similar technology, and uses industry-standard software technologies such as XML, Simple Object Access Protocol (SOAP), Web Services Description Language (WSDL), Universal Description, Discovery and Integration (UDDI), etc. The key participants in a Web Service include service providers, service brokers, and service consumers. Service providers are participants who desire to publish a service as a Web Service. Service brokers are participants who provide a registry and discovery mechanism for such services provided by all service providers. Service consumers are the immediate consumers of the Web Services offered by the service providers.

The basic process involved in the utilization of a Web Service includes the service provider providing a Web Service, which may be built from scratch or could wrap in existing legacy systems. A Web Service interface wraps the service, enabling an appropriate client to invoke the service interfaces with Web Service technologies. The service provider describes the service, its interfaces, and the mechanism to invoke the service interfaces in order to utilize their functionalities. This description utilizes a standard service description mechanism such as the Web Services Description Language (WSDL), which is then registered with the service brokers to allow discovery by the service consumers. The service providers use the interface provided by the service broker to manage the published service description. These Web Services interfaces provide an opportunity for carriers to offer their assets to any service provider who might benefit from such services. These assets may include, for example, billing capabilities, location or presence information, and the like. Web Service consumers/automated Web Service utilization applications (hereinafter referred to as consumers/applications), utilize the Web Service interfaces provided by the service broker to discover and identify the correct Web Service. On finding the relevant Web Service description, the consumer/application will interpret the invocation mechanism described, and dynamically invoke and communicate with the Web Service found.

Currently, the communication between the service consumer, service provider, and service broker may be established by a SOAP-based interaction. SOAP provides a message framework, which defines the message structure and processing mechanism, a set of encoding rules to represent service-specific data types, and a convention to enable remote procedure calls or the exchange of messages. A SOAP message includes three main elements, including the root envelope element, an optional header element, and a body element.

It should be noted that for purposes of the description provided herein, the Web Service consumer, e.g., service consumer or application, generally refers to the entity that is using the Web Service. An entity may itself be a service provider, by virtue of a service offering through its own Website, while also being a consumer of a Web Service provided by a mobile operator. Thus, a Web Service offering is not necessarily relegated to landline networks, but may also be offered by mobile terminals that implement adequate processing capability.

One aspect of the present invention involves the case where a Web Service is provided by a mobile terminal such as, for example, where the mobile terminal provides its position, so long as the appropriate location functionality, e.g., a Global Positioning System (GPS), exists within the mobile terminal. In such an instance, the service consumer/application may request position information from the mobile terminal directly in a translated SOAP format in accordance with the present invention. Accordingly, the translated SOAP representation is transmitted to the mobile terminal using a lower bandwidth channel, while the response may also be returned in a similarly translated SOAP representation to conserve bandwidth. Thus, in embodiments of the present invention, the mobile terminals serve as service providers, and third party or other entities on the network are service consumers. Therefore, where embodiments of the invention involve the case where the Web Service is offered by the mobile terminal, the service consumer/application generally refers to an entity that communicates with, for example, a WAP gateway that is operating as the access point between the landline network and the mobile domain.

It should be recognized that the present invention is also operable in the opposite direction, i.e., where the mobile terminal is the Web Service consumer. In such an instance, the mobile terminal requests a Web Service via, for example, a WAP gateway through the use of a translated SOAP representation. The WAP gateway then detects the use of a translated SOAP representation in accordance with the present invention and in response, creates a conventional SOAP/XML representation for subsequent transfer to the network entity that is offering the particular Web Service. Once the Web Service responds to the request, the WAP gateway detects the use of conventional SOAP/XML representations. Upon this detection, the WAP gateway then optionally translates the conventional SOAP/XML response into a translated SOAP representation based upon the capabilities of the mobile terminal. The translated SOAP/XML response may then be forwarded onto the mobile terminal through the use of a low bandwidth, OTA channel.

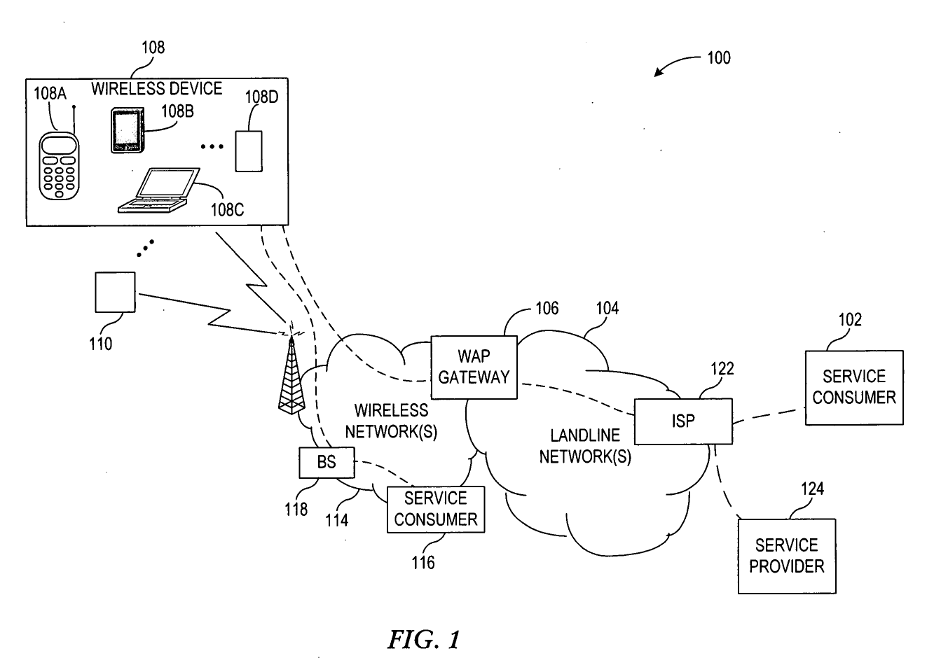

FIG. 1 illustrates a representative network 100 implementing the principles of the present invention whereby service consumers/applications can transparently utilize Web Services without the need to exchange conventional SOAP/XML messaging. In the example of FIG. 1, a service consumer/application 102 may be coupled to a landline network 104, such as the Internet, via ISP 122. WAP gateway 106 serves as the access point between mobile operator network 114 and landline network 104, whereby messages sent from service consumer 102 to mobile terminal 108, 110 are sent through WAP gateway 106. Terminals 108 and 110 may include mobile phones 108A, Personal Digital Assistants (PDA) 108B, portable computing devices 108C, or other 108D wireless devices.

Service consumer/application 102 may communicate with WAP gateway 106 via ISP 122 on landline network 104, whereby WAP gateway 106 in turn communicates OTA with devices coupled to wireless network 114. A service consumer/application 116 may also communicate with terminals 108 wirelessly via Base Station 118. In such an instance, BS 118 provides the access point between service consumer/application 116 and wireless devices 108, 110, whereby BS 118 provides SOAP/XML detection/translation in accordance with the present invention. In one embodiment of the invention, BS 118 detects a translated SOAP representation sent from service consumer/application 116 and subsequently provides the translated SOAP representation to/from wireless devices 108, 110.

In another embodiment according to the present invention, ISP 122 acts as the access point between service consumer/application 102 and service provider 124. In such an instance, ISP 122 provides any SOAP translation/filtering processes that may be required by service consumer/application 102 due to any computational resource deficiency that it may have. Thus, conventional SOAP/XML representations sent/received to/from service provider 124 may be converted by ISP 122 into a translated SOAP representation prior to being exchanged with service consumer/application 102.

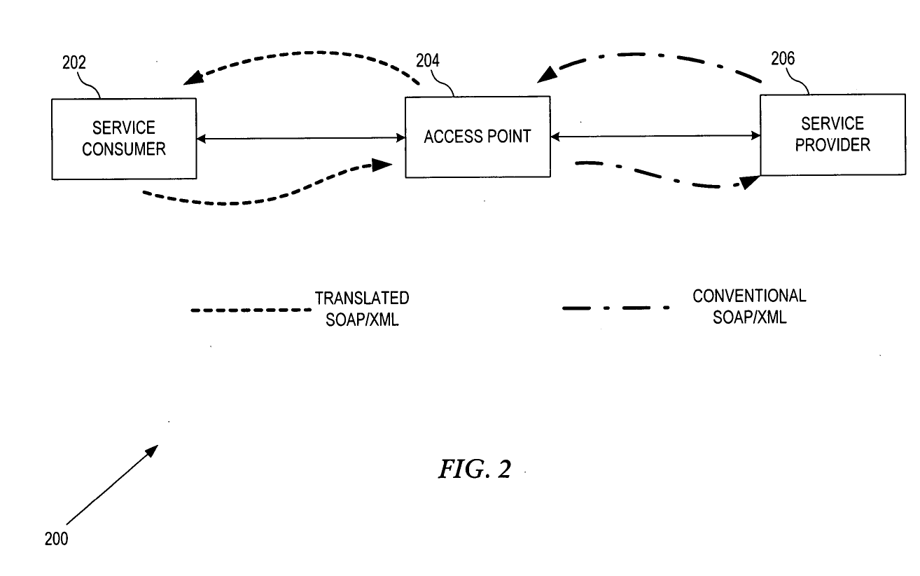

Messages between the service consumers and the service providers may be sent using conventional SOAP/XML or translated SOAP/XML in accordance with the present invention. As such, the SOAP access point, e.g., WAP gateway 106, BS 118, or ISP 122 of FIG. 1, is required to first detect the presence of SOAP/XML content, whether it be conventional or translated, and then perform the SOAP/XML conversion (if any is required) before forwarding onto the network end point. An example of a typical message exchange is illustrated in FIG. 2, which illustrates a block diagram of basic network architecture 200 incorporating SOAP access point 204 in accordance with the present invention.

As previously described, service consumer/application 202 may represent either a mobile or landline terminal that exhibits limited processing power, whose capabilities would be excessively burdened by conventional SOAP/XML representation processing. As such, service consumer/application 202 issues a translated SOAP/XML request to access point 204, such that by virtue of such a translated request, access point 204 ultimately responds with a translated SOAP/XML response, once a response has been received from service provider 206, in accordance with the present invention.

Once access point 204 has received a SOAP/XML message from service provider 206, it may use alternate means of detecting the existence of SOAP content within the message. In one embodiment according to the present invention, a SOAPAction header may be provided by service provider 206, which signals access point 204 as to the existence of SOAP content. Once detected, access point 204 may then retrieve the actual payload from the SOAP/XML message and encapsulate the payload into a message format, i.e., the translated SOAP/XML representation, that is compatible with service consumer 202.

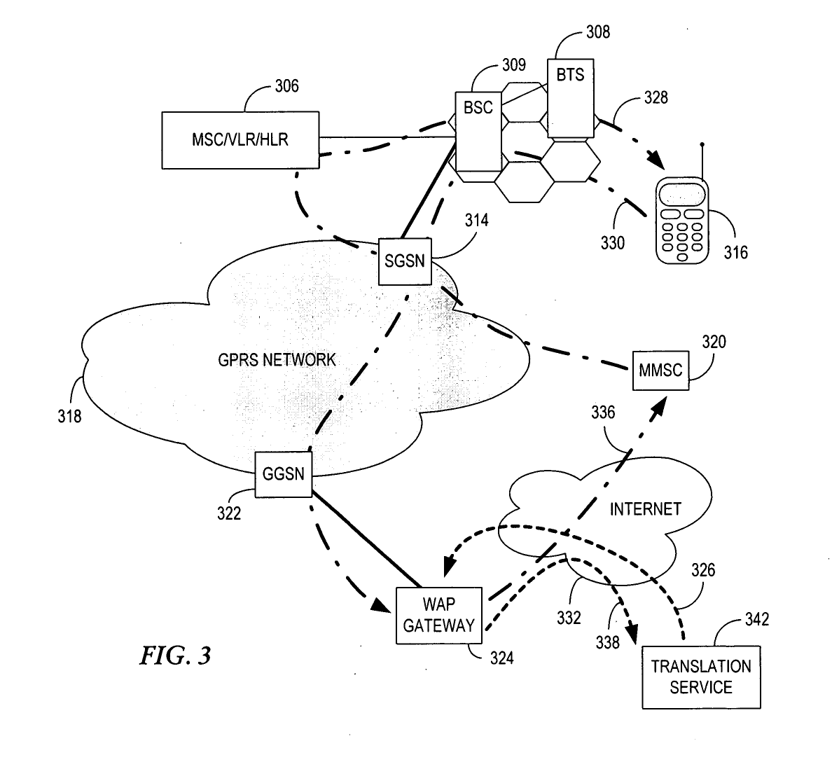

It should be noted that while many Web Service request/response scenarios exist that are in accordance with the present invention, exemplary system and Web Service request scenario 300 of FIG. 3 is now explained for purposes of illustration and not of limitation. FIG. 3 is a diagram illustrating an exemplary embodiment of a General Packet Radio Service (GPRS) implementation of Web Services access from a mobile terminal, e.g., service consumer 202 of FIG. 2, from a service provider, e.g., service provider 206 of FIG.2.

GPRS is a packet-switched service for the Global System for Mobile Communications (GSM) that mirrors the Internet model and enables seamless transition towards 3G (third generation) networks. GPRS thus provides actual packet radio access for mobile GSM and time-division multiple access (TDMA) users, and is ideal for WAP services. While the exemplary embodiments of FIG. 3 are generally described in connection with GPRS/GSM, it should be recognized that the specific references to GSM and GPRS are provided to facilitate an understanding of the invention. As will be readily apparent to those skilled in the art from the description provided herein, the invention is equally applicable to other technologies, including other circuit-switched and packet-switched technologies, 3G technologies, and beyond.

Referring to FIG. 3, mobile terminal 316 communicates with Base Transceiver Station (BTS) 308 via an OTA interface. BTS 308 is a component of the wireless network access infrastructure that terminates the OTA interface over which subscriber traffic is communicated to and from mobile terminal 316. Base Station Controller (BSC) 309 is a switching module that provides, among other features, handoff functions, and power level control in BTS 308. BSC 309 controls the interface between a Mobile Switching Center (MSC) 306 and BTS 308, and thus controls one or more BTSs in the call set-up functions, signaling, and in the use of radio channels. BSC 309 also controls the interface between Serving GPRS Support Node (SGSN) 314 and BTS 308.

SGSN 314 serves a GPRS mobile terminal by sending or receiving packets via a Base Station Subsystem (BSS), and more particularly via BSC 309 in the context of GSM systems. SGSN 314 is responsible for the delivery of data packets to and from mobile terminal 316 within the service area, and performs packet routing and transfer, mobility management, logical link management, authentication, charging functions, etc. In the exemplary GPRS embodiment shown in FIG. 3, the location register of SGSN 314 stores location information such as the current cell and Visiting Location Register (VLR) associated with mobile terminal 316, as well as user profiles such as the International Mobile Subscriber Identity Number (IMSI) of all GPRS users registered with SGSN 314. SGSN 314 is ultimately coupled to MMSC 320 in connection with the presently described embodiment. While GSM forms the underlying technology, SGSN 314 described above is a network element introduced through GPRS technology. Another network element introduced in the GPRS context is the Gateway GPRS Support Node (GGSN) 322, which acts as a gateway between the GPRS network 318 and WAP gateway 324.

MMSC 320, which may either be co-located or separate from WAP gateway 324, provides messaging capabilities for the delivery of multimedia messages composed of text, photographs, video, and other media types. The messaging capabilities include mobile originated messages sent to other mobile terminals or applications and application originated messages sent to mobile terminals or other applications. MMSC 320 is responsible for storing incoming and outgoing MMS messages, as well as the transfer of messages between different messaging systems.

With the aforementioned network system described as a representative network environment, a Web Service access scenario is now described in accordance with the present invention. Mobile terminal 316 acts as the Web Service consumer seeking, for example, to receive a Spanish translation of an English phrase, whereby translation service 342 acts as the Web Service provider for Internet 332 that performs the English-Spanish translation. Dashed line 330 represents the Web Service request from mobile terminal 316 using, for example, the WAP protocol suite. The WAP protocol suite is used as the data transport mechanism because WAP provides data transport services that are optimized for mobile networks. WAP also provides uniform transport services regardless of the underlying network. In particular, the Wireless Session Protocol (WSP) layer supplies the basis of the transport mechanism, whereby Multimedia Messaging Service (MMS) Protocol Data Units (PDU) are used to transport the messages.

Mobile terminal 316 invokes a WSP/HTTP POST operation with an M-Send.req message imbedded as the content body, which requests translation service 342. The M-Send.req message consists of headers and a message body, whereby the headers mainly contain information as to how to transfer the message from the originator, e.g. mobile terminal 316, to the destination, e.g. translation service 342. The information may contain such information as source unit identification, sink unit identification, message identification, content type, etc. In particular, the headers may also contain a token that may be used to instruct WAP gateway 324 to forward the service request of message 330 via a conventional SOAP/XML representation to translation service 342 via message 338.

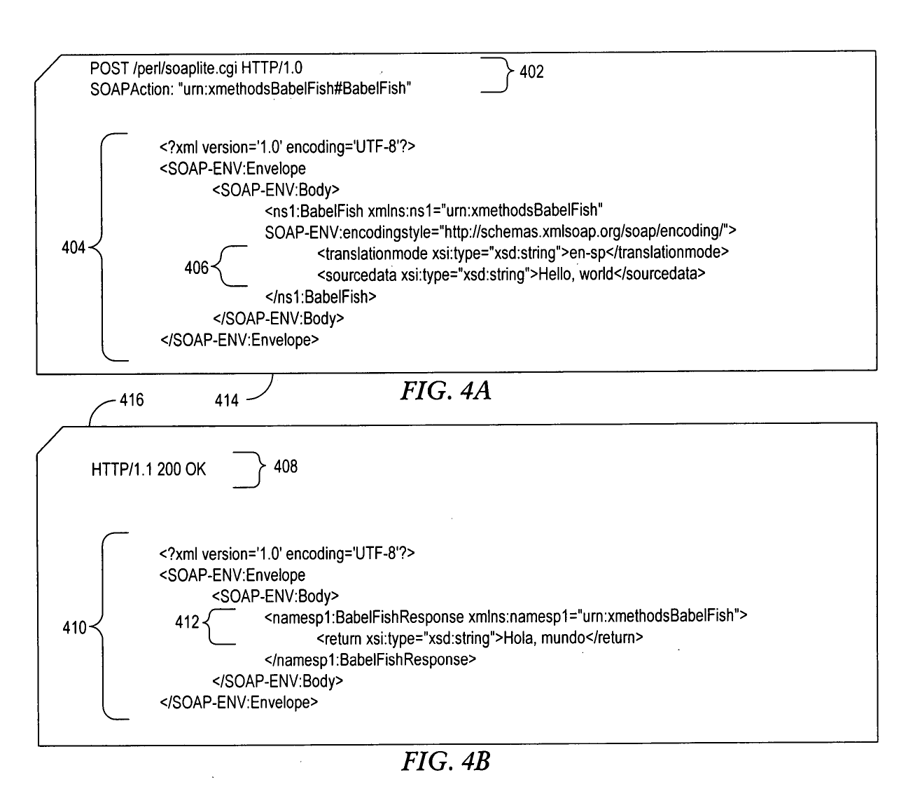

FIG. 4A illustrates a typical representation of conventional SOAP request 338 that is formed by WAP gateway 324 upon receipt of message 330. Translation service 342 represents, for example, the AltaVista BabelFish translation service hosted by XMethods. WAP gateway 324 first examines the header tokens contained within M-Send.req message 330 and in response, determines that mobile terminal 316 has requested, for example, a translation of the English phrase “Hello, world”. WAP gateway 324 then encapsulates SOAP/XML content 404 within HTTP message 414 and supplies HTTP message header 402, which specifies that the SOAP action to be taken is the BabelFish translation service hosted by XMethods. WAP gateway 324 further includes BabelFish method 406 within SOAP/XML content 404, which requests an English-Spanish translation, i.e., en-sp, of the source data phrase, “Hello, world”.

FIG. 4B illustrates a typical representation of conventional HTTP response 326 that is sent from translation service 342 to WAP gateway 324 in response to the Web Service request of message 338. In particular, HTTP message 416 contains HTTP header 408 indicating that the service request was completed successfully, i.e., “200 OK”. Further, WAP gateway 324 detects the presence of SOAP content 410, where in particular, the translation of the English phrase “Hello, world” to the Spanish phrase “Hola, mundo”, is contained within SOAP body 412.

In accordance with the present invention, WAP gateway 324 determines that SOAP/XML representation 410 is not to be transmitted OTA to mobile terminal 316 due to its limited processing capability. The limited processing capability may have been previously determined during, for example, a capabilities exchange according to the User Agent Profile (UAProf) specification. Conversely, mobile terminal 316 may have indicated the existence of limited computational facilities through the use of a header token contained within message 330. Accordingly, a translated SOAP/XML representation is used to deliver the translated text to mobile terminal 316. In particular, WAP gateway 324 may utilize, for example, HTTP POST request message 336 to deliver an encapsulation of SOAP body 412 to Multimedia Messaging Service Center (MMSC) 320.

Once SOAP encapsulated HTTP POST request message 336 has been transmitted to MMSC 320 by WAP gateway 324, an indication as to the SOAP content receipt is provided to mobile terminal 316, which is denoted by translated SOAP/XML message 328. Notification 328, for example, may utilize push semantics defined by the Open Mobile Alliance (OMA), which delivers a receipt notification to the receiving device, e.g., mobile terminal 316. The MMS PDU that is used to send the notification message within the push message is M-Notification.ind. The M-Notification.ind informs mobile terminal 316 about the contents of received message 336 and its purpose is to allow mobile terminal 316 to fetch the SOAP content of message 336 from MMSC 320. Once notification message 328 has been received, a WAP/GET operation may either be automatically or manually initiated in order for mobile terminal 316 to receive the content specified by the Uniform Resource Indicator (URI) of notification message 328. Although an MMS example has been explored,,one of ordinary skill in the art will recognize that other delivery mechanisms may be used to deliver translated SOAP/XML representations to mobile terminal 316, such as with the Short Message Service (SMS) or Instant Messaging (IM) as implemented using the Session Initiation Protocol (SIP), for example.

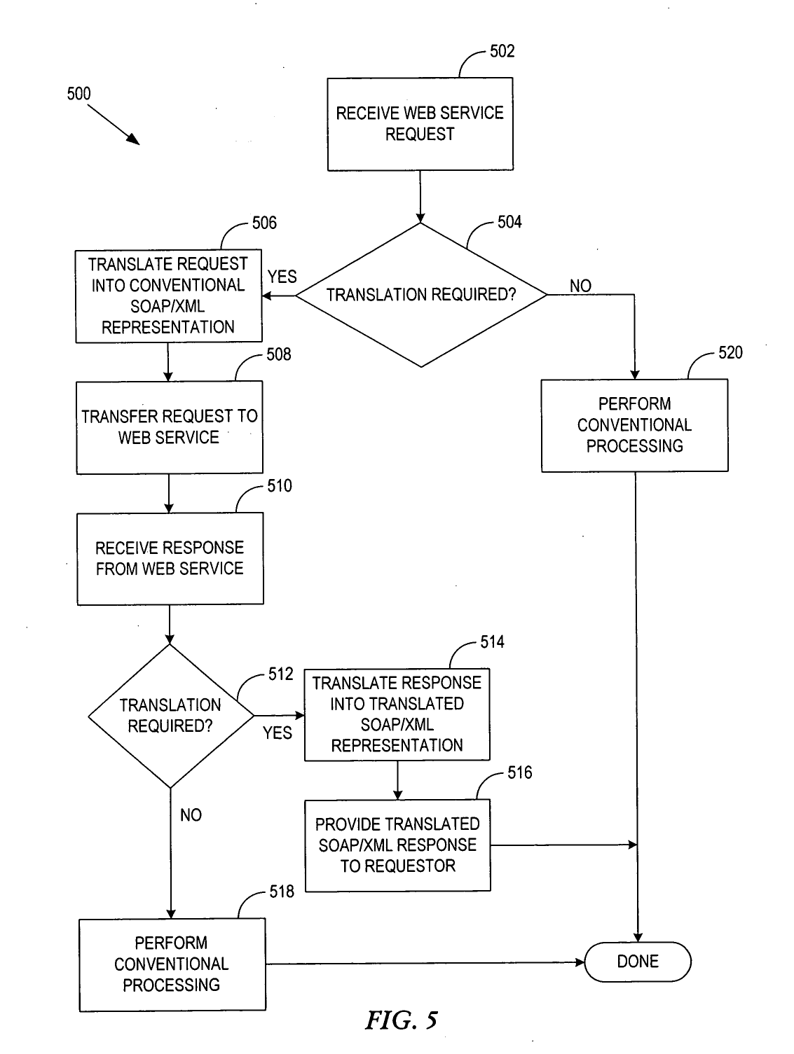

The present invention utilizes a filtering and translation module within a network access point, such that flow diagram 500 of FIG. 5 may be executed whenever conventional SOAP/XML representations are optionally to be translated/filtered at the access point prior to being forwarded onto the requesting terminal. In step 502, for example, a Web Service request, e.g., message 330, is received by the access point, e.g., WAP gateway 324, from the service requester, e.g., mobile terminal 316. The access point then analyzes the request in step 504 to determine whether the request should be forwarded as a conventional, or conversely as a translated, SOAP/XML request. Such a determination may be made, for example, by examining header information within message 330, or conversely, the determination may be made through a capability information exchange between the access point and the service requester. If no translation is required, then step 520 is taken, whereby conventional SOAP/XML representations may be exchanged to complete the Web Service request.

If, however, translations are required, then the Web Service request that was received in message 330 is a translated SOAP/XML request and must first be converted via step 506 into a conventional SOAP/XML representation, e.g., HTTP encapsulation 414. Once converted, the request is then forwarded onto the Web Service provider, e.g., translation service 342, via step 508. The response, e.g., HTTP encapsulation 416, received from the Web Service provider in step 510 must then be analyzed by the access point to determine the need for translation. Either the presence of, for example, a SOAPAction header, or the presence of SOAP content may be detected by the access point. This detection in combination with the knowledge that the Web Service requestor requires a translated SOAP/XML representation, allows the access point to determine the need for translation as in step 512. If no translation is required, then the conventional SOAP/XML processing of step 518 may conclude the transaction.

If translation is required, however, then HTTP encapsulation 416 must first be translated into an appropriate format for use with mobile terminal 316, e.g., MMS, SMS, or IM messaging, as discussed above. Once translated, the response may then be provided to the Web Service requester in step 516 to complete the transaction.

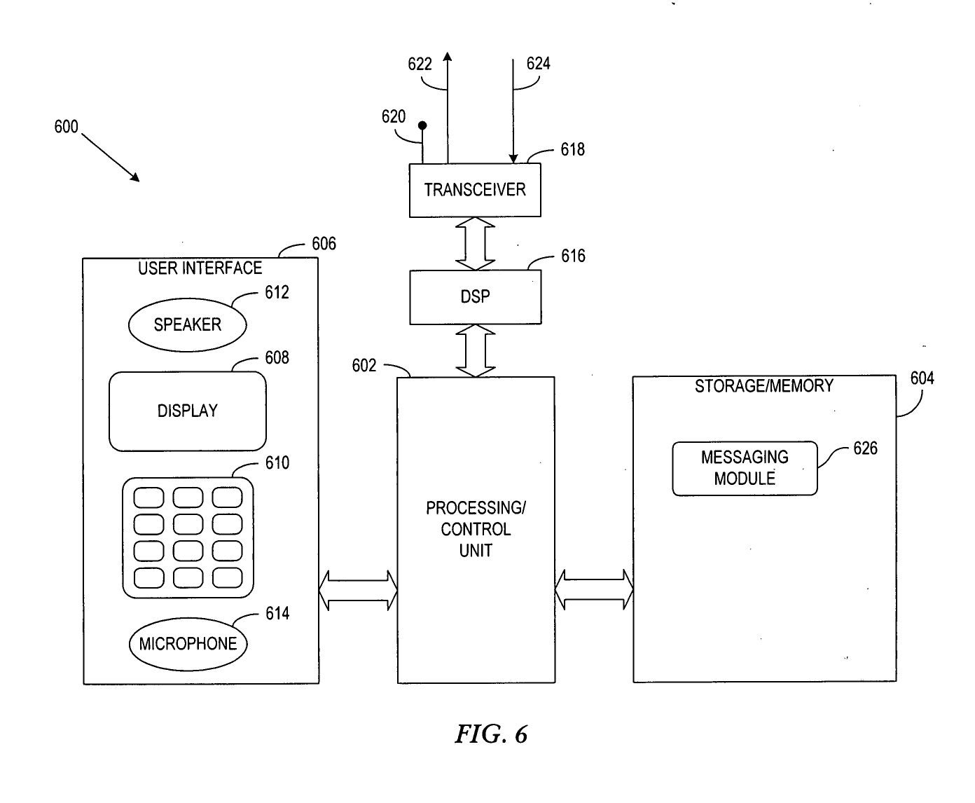

The invention is a modular invention, whereby processing functions within either a land based terminal, a mobile terminal, or a network access point may be utilized to implement the present invention. The mobile devices may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the functionality provided by the present invention. Hardware, firmware, software or a combination thereof may be used to perform the various messaging functions described herein. An example of a representative mobile terminal computing system capable of carrying out operations in accordance with the invention is illustrated in FIG. 6. Those skilled in the art will appreciate that the exemplary mobile computing environment 600 is merely representative of general functions that may be associated with such mobile devices, and also that landline computing systems similarly include computing circuitry to perform such operations.

The exemplary mobile computing arrangement 600 suitable for off-loading any SOAP related translation/filtering functions to network access points may be associated with a number of different types of wireless devices. The representative mobile computing arrangement 600 includes a processing/control unit 602, such as a microprocessor, reduced instruction set computer (RISC), or other central processing module. The processing unit 602 need not be a single device, and may include one or more processors. For example, the processing unit may include a master processor and associated slave processors coupled to communicate with the master processor.

The processing unit 602 controls the basic functions of the mobile terminal, and also those functions associated with the present invention as dictated by messaging module 626 available in the program storage/memory 604. Thus, the processing unit 602 is capable of determining whether sufficient processing capability exists to perform conventional SOAP/XML processing. If the processing capability is deficient, then the processing unit 602 may interact with messaging module 626 to off-load the translation/filtering of the SOAP/XML content to the relevant network access point in accordance with the present invention. The program storage/memory 604 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 604 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be-transmitted to the mobile computing arrangement 600 via data signals, such as being downloaded electronically via one or more networks, such as the Internet and an intermediate wireless network(s).

The processor 602 is also coupled to user-interface 606 elements associated with the mobile terminal. The user-interface 606 of the mobile terminal may include, for example, a display 608 such as a liquid crystal display, a keypad 610, speaker 612, and microphone 614. These and other user-interface components are coupled to the processor 602 as is known in the art. Other user-interface mechanisms may be employed, such as voice commands, switches, touch pad/screen, graphical user interface using a pointing device, trackball, joystick, or any other user interface mechanism.

The mobile computing arrangement 600 also includes conventional circuitry for performing wireless transmissions. A digital signal processor (DSP) 616 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 618, generally coupled to an antenna 620, transmits the outgoing radio signals 622 and receives the incoming radio signals 624 associated with the wireless device.

The mobile computing arrangement 600 of FIG. 6 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to implement usage of a network access point for transparent Web Service functionality in accordance with the present invention.

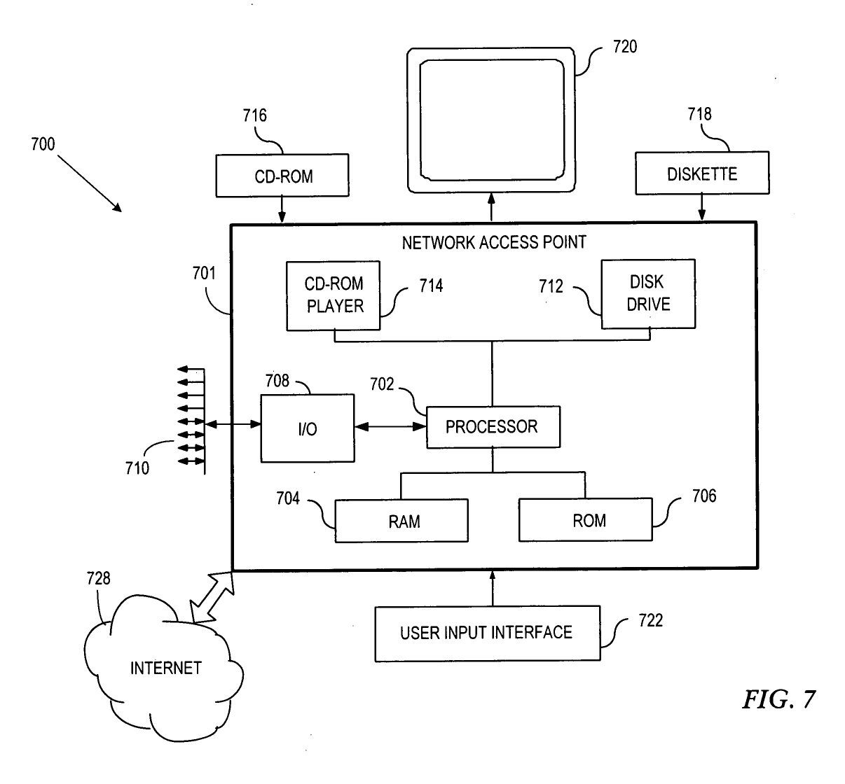

The network access points or other systems for providing messaging functions in connection with the present invention may be any type of computing device capable of processing and communicating digital information. The network access points utilize computing systems to control and manage the messaging activity. An example of a representative computing system capable of carrying out operations in accordance with the invention is illustrated in FIG. 7. Hardware, firmware, software or a combination thereof may be used to perform the various messaging functions and operations described herein. The computing structure 700 of FIG. 7 is an example computing structure that can be used in connection with such a messaging system.

The example computing arrangement 700 suitable for performing the messaging activity in accordance with the present invention includes network access point 701, which includes a central processor (CPU) 702 coupled to random access memory (RAM) 704 and read-only memory (ROM) 706. The ROM 706 may also be other types of storage media to store programs, such as programmable ROM (PROM), erasable PROM (EPROM), etc. The processor 702 may communicate with other internal and external components through input/output (I/O) circuitry 708 and bussing 710, to provide control signals and the like. For example, a translated SOAP/XML message such as that exemplified by message 330 may be received by network access point 701 to enable transparent Web Service functionality between a Web Service requester that requires translated SOAP/XML representations and a Web Service provider that requires conventional SOAP/XML representations. External data storage devices, such as a profile server, may be coupled to I/O circuitry 708 to facilitate capability information transfer. Alternatively, such databases may be locally stored in the storage/memory of network access point 701, or otherwise accessible via a local network or networks having a more extensive reach such as the Internet 728. The processor 702 carries out a variety of functions as is known in the art, as dictated by software and/or firmware instructions.

Network access point 701 may also include one or more data storage devices, including hard and floppy disk drives 712, CD-ROM drives 714, and other hardware capable of reading and/or storing information such as DVD, etc. In one embodiment, software for carrying out the messaging operations in accordance with the present invention may be stored and distributed on a CD-ROM 716, diskette 718 or other form of media capable of portably storing information. These storage media may be inserted into, and read by, devices such as the CD-ROM drive 714, the disk drive 712, etc. The software may also be transmitted to network access point 701 via data signals, such as being downloaded electronically via a network, such as the Internet. Network access point 701 is coupled to a display 720, which may be any type of known display or presentation screen, such as LCD displays, plasma display, cathode ray tubes (CRT), etc. A user input interface 722 is provided, including one or more user interface mechanisms such as a mouse, keyboard, microphone, touch pad, touch screen, voice-recognition system, etc.

The network access point 701 may be coupled to other computing devices, such as the landline and/or wireless terminals via a network. The network access point may be part of a larger network configuration as in a global area network (GAN) such as the Internet 728, which allows ultimate connection to the various landline and/or mobile client/watcher devices.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather defined by the claims appended hereto.

1. A method for transparently accessing Web Services by a network terminal via a network access point, the method comprising:
receiving a Web Service request from the network terminal by the network access point;
optionally translating the Web Service request into a first format;
receiving a Web Service response in the first format; and
optionally translating the Web Service response into a second format, wherein the second format is indicative of processing capabilities of the network terminal.

2. The method according to claim 1, wherein translation of the Web Service request is performed in response to receiving a translation indication from the network terminal.

3. The method according to claim 2, wherein the translation indication is received with the Web Service request.

4. The method according to claim 2, wherein the translation indication is received through a capabilities information exchange with the network terminal.

5. The method according to claim 1, wherein translation of the Web Service response is performed in response to receiving the translation indication from the network terminal.

6. A Web Service consumption system, comprising:
a network terminal adapted to request a Web Service in a translated format and adapted to receive a response to the request in the translated format;
a network access point coupled to receive the request and adapted to convert the request into a conventional format; and
a service provider coupled to receive the request from the network access point and adapted to provide the response to the request in the conventional format, wherein the network access point is further adapted to convert the response into the translated format prior to forwarding the response to the network terminal.

7. The Web Service consumption system according to claim 6, wherein the network terminal is further adapted to command the network access point to convert the request into the conventional format.

8. The Web Service consumption system according to claim 7, wherein the network terminal is further adapted to command the network access point to convert the response into the translated format.

9. The Web Service consumption system according to claim 6, wherein the translated format comprises a wireless messaging format.

10. The Web Service consumption system according to claim 9, wherein the wireless messaging format comprises Multimedia Messaging System (MMS) format.

11. The Web Service consumption system according to claim 6, wherein the conventional format comprises Simple Object Access Protocol (SOAP).

12. The Web Service consumption system according to claim 11, wherein the conventional format further comprises eXtensible Markup Language (XML).

13. A mobile terminal capable of being wirelessly coupled to a network which includes a network access point capable of translating Web Service exchanges between the mobile terminal and a service provider, the mobile terminal comprising:
a memory capable of storing a messaging module;
a processor coupled to the memory and configured by the messaging module to enable a message exchange with the network access point, wherein the messaging module is adapted to instruct the network access point to convert the messages received from the mobile terminal to a format compatible with the service provider.

14. The mobile terminal according to claim 13, wherein the messaging module provides the conversion instruction to the network access point within a service request.

15. The mobile terminal according to claim 13, wherein the messaging module provides the conversion instruction to the network access point during a capabilities exchange with the network access point.

16. A computer-readable medium having instructions stored thereon which are executable by a network terminal for consuming Web Services by performing steps comprising:
transmitting a Web Service request in a first format to a network access point;
signalling the network access point to convert the Web Service request from the first format to a second format; and
receiving a response to the Web Service request from the network access point, wherein the response received is also in the first format.

17. A network access point within a network used to facilitate a Web Service exchange between a service requestor and a service provider, comprising:
means for receiving a service request in a first format from the service requestor;
means for translating the service request from the first format into a second format in response to signalling received from the service requester;
means for receiving a service response in the second format from the service provider; and
means for translating the service response from the second format to the first format in response to signalling received from the service requester.

18. A computer-readable medium having instructions stored thereon which are executable by a network access point for facilitating Web Service consumption by performing steps comprising:
receiving a service request in a first format from the service requestor;
translating the service request from the first format into a second format in response to signalling received from the service requestor;
receiving a service response in the second format from the service provider; and
translating the service response from the second format to the first format in response to signalling received from the service requestor.
